(19) United States
(12) Patent Application Publication
(10) Pub. No.: US 2015/0234360 A1
(43) Pub. Date: Aug. 20, 2015

(54) Construction arrangement applied to electromagnetic or magnetic watch

(71) Applicant: Leon Gerhard KARSTEN, Rio de Janeiro (BR)

(72) Inventor: Leon Gerhard KARSTEN, Rio de Janeiro (BR)

(21) Appl. No.: 14/575,317

(22) Filed: Dec. 18, 2014

(30) Foreign Application Priority Data
Dec. 18, 2013 (BR) BR2020130326114

(51) Int. Cl. G04C 5/00

(52) U.S. Cl. CPC G04C 5/005

(57) ABSTRACT

CONSTRUCTIVE ARRANGEMENT APPLIED IN ELECTROMAGNETIC OR MAGNETIC WATCH, consisting of a mechanism that works by magnetic force. In this condition, besides proportioning the user an option for a mechanism with low power consumption, enables that the same be constructed in a total transparent form, without the need of traditional pinions and gears than that of traditional watches.

The following descriptive report of the utility patent refers to the development of a construction arrangement applied to an electromagnetic or magnetic watch, consisting of a mechanism that works with magnetic force. In this condition, besides proportioning the user an option for a mechanism with low power consumption, enables that the same be constructed in a total transparent form, without the need of traditional pinions and gears than that of traditional watches.

### Previous Inventions

Equipment and instruments developed to verify the counting of hours, with diverse specific properties are already very common among previous inventions.

The most similar product at this moment is an analogue watch. These watches work on an electro-mechanical principle (electrical cell [battery] inducing mechanical movement of the watch hands) or mechanical (tensioned springs inducing mechanical movement of the watch hands). These products work on another technology which demands the use of many wheels, pinions, balancing wheels, hair springs, pallet fork, etc. This makes it impossible to construct the watch in a very transparent form.

There exists in the market a series of devices for various types of activities. In a research done on the data base of the National Institute of Industrial Property, we found the existence of some technologies developed for such a function. But let's see:

On Mar. 23, 2011, filed the patent request MU 9100557-4, consisting of a provision introduced in a wristwatch with interchangeable casing, created for a wristwatch, whose casing containing the mechanism can be coupled to different models retention rings with their watchbands, by simple fitting, without the need for special tools, belongs to the field of personal items; called wrist watch with interchangeable casing is made from an interchangeable mechanism casing in a predominantly discoid format, which contains a complete watch mechanism; the interchangeable mechanism casing referred to has standardized format and size, to be embedded in the retention rings fitted with watchbands, which have internal holes of standard and compatible coupling with the same, but have variable external geometries and their respective bracelets, which can be made of various materials and formats.

On Oct. 16, 2009, filed the patent request MU 8902267-0, consisting of a provision introduced in a wristwatch referring to an innovative constructive provision applied to one of the most simplest and practical objects of our current society, which is the wristwatch. The current invention is basically composed of a complete silicone-based or similar bracelet whose front part is provided with a reinforced rip and recessed envelope back which fits the whole machine, analog, digital, or analog-digital. The operation thereof is extremely simple, since the silicone strap fits snugly any wrist and can be exchanged for any other of any color, texture or design, since the machine assembly fits perfectly in the recess, thus giving various possibilities of use for any situation.

Finally, on Jul. 27, 2007, filed the patent request MU 8701891-8, consisting of a watch with virtual watch hands, referring to an analog watch that is comprised of a machine for conventional analog clock, with hour axes, a base disc with hour and minute markings, fixed to the mechanism of the watch and a transparent and rotating mobile disk. In the base disc are markings, being 12 markings indicating the hours, each hour is divided into 4 quarters of an hour. Also on the base is a set of lines called the base graphic pattern. The mobile disk fits to the hour rotation axis, consisting of a transparent hard plastic disc, has engraved another graphic pattern called the top graphic pattern. The indicator is a visual effect, generated by the interference of the graphicpatterns when superimposed. This visual effect indicates the hours and 05 minutes.

That said, when referring exclusively to the use of electromagnetic or magnetic energy (magnetism) to drive the watch hands, not any constructive provisions are known that are able to offer the benefits proposed in this report.

### Proposed development

With due consideration to previous inventions, the object of the current application is the development of constructive arrangement applied in electromagnetic or magnetic watch, consisting of a mechanism that works through magnetic force. This equipment, operating on the principle of magnetism, pulls or pushes the watch hands in the desired direction. In addition, the watch has the property to be transparent while still using watch hands, allowing the user to change the watch background, or remove the background to appear transparent.

### DESCRIPTION OF THE FIGURES

The characterization of the utility model patent application proposed herein is made by means of drawings representing the constructive arrangement applied to the electromagnetic or magnetic watch, so that the object can be reproduced by appropriate technology, allowing for full characterization of the functionality and exclusivity of the pleaded object.

From the elaborate figures, which express the best or preferred way to accomplish the device now idealized, is based on the descriptive part of the report, through detailed and consecutive numbering, where this clarifies aspects that may be implied by the adopted representation, in order to clearly determine the protection now pled.

These figures are for illustration purposes only and may vary, provided they do not flee the initially pleaded principle.

In this case we have:

FIG. 1 illustrates the front image of the casing and hands, focusing on the electromagnetic or magnetic ring/disc.

FIG. 2 illustrates the front image of the casing and hands, focusing on the motor or gear that makes the ring/disc move.

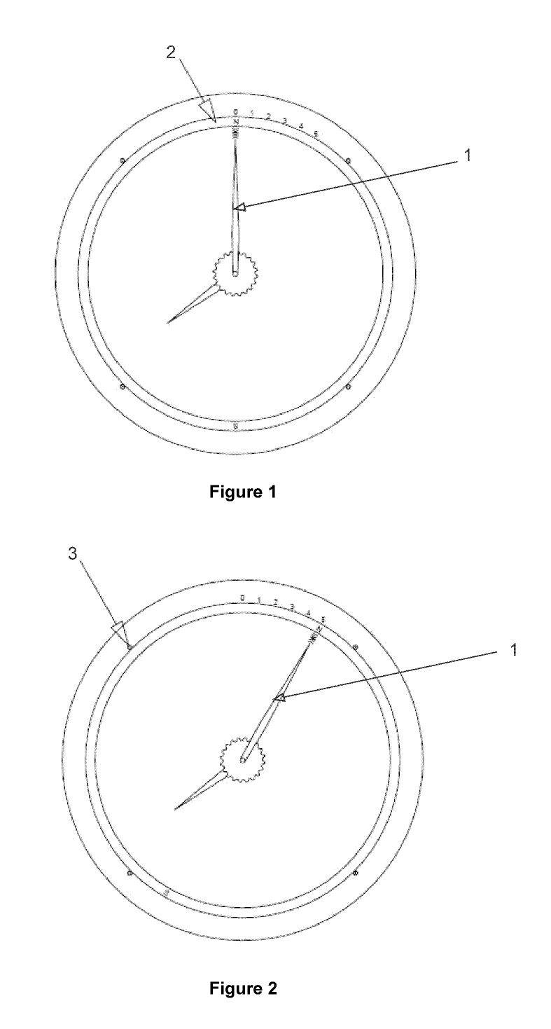

### CLAIMS

Constructive layout applied in the electromagnetic or magnetic watch, being a mechanism shaped by a casing that houses the watch hands (1) with magnetic properties allowing its uniform movement by means of electromagnetic or magnetic properties of the ring/disc (2), placed in the entire diameter of the casing.

Constructive arrangement applied in electromagnetic or magnetic watch, whose movement of the hands is made by the magnetism of the electromagnetic or magnetic ring/disc (2), which in turn is moved by the power of the motor/gear (3) coupled to the electronic/mechanical watch. The watch hand moves through the movement of the electromagnetic or magnetic ring/disc (2).

Constructive arrangement applied in electromagnetic or magnetic watch whose hands (1) accompany the movement, being connected to the initial hand by the gear in the middle.

1. CONSTRUCTIVE LAYOUT APPLIED IN THE ELECTROMAGNETIC OR MAGNETIC WATCH, characterized by an equipment used for the verification of hours, being that its principle invention consists in the possibility of working with electromagnetic or magnetic energy, having this working principle made possible by a casing that houses the watch hands with magnetic properties allowing its uniform movement by means of electromagnetic or magnetic properties of the ring/disc, placed in the entire diameter of the casing.

2. CONSTRUCTIVE ARRANGEMENT APPLIED IN ELECTROMAGNETIC OR MAGNETIC WATCH, whose movement of the hands is made by the magnetism of the electromagnetic or magnetic ring/disc, which in turn is moved by the power of the motor/gear coupled to the electronic/mechanical watch. The watch hand moves through the movement of the electromagnetic or magnetic ring/disc.

3. CONSTRUCTIVE ARRANGEMENT APPLIED IN ELECTROMAGNETIC OR MAGNETIC WATCH, whose hands (1) accompany the movement, being connected to the initial hand by the gear in the middle.
